(19) United States
(12) Patent Application Publication
(10) Pub. No.: US 2005/0001427 A1
(43) Pub. Date: Jan. 6, 2005

(54) Low profile connector

(75) Inventor: Joseph Shu Yian Liew, Carlingford (AU)

Correspondence Address: WILLIAMS, MORGAN & AMERSON, P.C., 10333 RICHMOND, SUITE 1100, HOUSTON, TX, 77042, US

(73) Assignee: FMC Technologies, Inc.

(21) Appl. No.: 10/848,932

(22) Filed: May 19, 2004

Related U.S. Application Data
(60) Provisional application No. 60/471,812, filed on May 20, 2003.

(51) Int. Cl. F16L 35/00

(52) U.S. Cl. 285/322

(57) ABSTRACT

The present invention is directed to various embodiments of a connector. In one illustrative embodiment, the connector comprises a first component, the first component adapted to be coupled to a second component, an outer collar positioned around the first component, the outer collar adapted to be threadingly coupled to the second component, and a plurality of collet fingers positioned between the outer collar and the first component, the outer collar having a surface that is adapted to engage the collet fingers and urge the collet fingers into engagement with the first and second components when the outer collar is threadingly coupled to the second component. The present invention is also directed to various methods of coupling a first component to a second component. In one illustrative embodiment, the method comprises rotatably coupling a rotatable outer collar to the first component, wherein a plurality of collet fingers are positioned between the rotatable outer collar and the first component, positioning the first component adjacent the second component, and rotatably coupling the outer collar to the second component, wherein a surface of the outer collar urges the collet fingers into engagement with the first and second components.

### RELATED CASES

The present application claims priority from provisional U.S. application Ser. No. 60/471,812 filed on May 20, 2003, which is hereby incorporated by reference in its entirety.

### BACKGROUND OF THE INVENTION

1. FIELD OF THE INVENTION

The present invention is generally related to the field of connectors, and, more particularly, to a low profile connector that may be employed to connect various components together. In various illustrative embodiments, the connector disclosed herein may be used as a wellhead, riser or flowline connector.

2. DESCRIPTION OF THE RELATED ART

In drilling and producing oil and gas wells, it is often necessary to connect two components to one another. For example, connectors may be employed to connect a wellhead to a Christmas tree, a riser, or another wellhead depending upon the particular application. Additionally, there are situations where two or more wells are mounted in the same conductor housing, i.e., a so-called multiple-completion well. An example of an multiple-completion well is disclosed in U.S. Patent Publication No. 2003/0006035, which is hereby incorporated by reference.

The close proximity of the wellheads in a multiple-completion application requires that the wellhead connectors be “low profile,” which means that the connectors have a relatively small outer diameter so that they do not interfere with each other. Existing low profile connectors have a somewhat limited capacity to withstanding bending loads exerted on the connector. Standard API flanged connections have a greater bending load capacity, but they are very time-consuming to install and are relatively large. Thus, there is a need for a low profile connector which withstand high bending loads and which allows the connection to be completed quickly, i.e., the connector allows the connection to be made in substantially less time as compared to flanged-type connectors.

The present invention is directed to an apparatus and methods for solving, or at least reducing the effects of, some or all of the aforementioned problems.

### SUMMARY OF THE INVENTION

The present invention is directed to various embodiments of a connector. In one illustrative embodiment, the connector comprises a first component, the first component adapted to be coupled to a second component, an outer collar positioned around the first component, the outer collar adapted to be threadingly coupled to the second component, and a plurality of collet fingers positioned between the outer collar and the first component, the outer collar having a surface that is adapted to engage the collet fingers and urge the collet fingers into engagement with the first and second components when the outer collar is threadingly coupled to the second component.

In another illustrative embodiment, the connector comprises a first component, the first component adapted to be coupled to a second component, an outer collar positioned around the first component, the outer collar adapted to be threadingly coupled to the second component, and a plurality of collet fingers positioned between the outer collar and the first component, the outer collar having a substantially cylindrical surface that is adapted to engage the collet fingers and urge the collet fingers into engagement with the first and second components when the outer collar is threadingly coupled to the second component, wherein each of the collet fingers has a first tapered surface that is adapted to engage a tapered surface formed on the first component and each of the collet fingers has a second tapered surface that is adapted to engage a tapered surface formed on the second component.

In yet another illustrative embodiment, the connector comprises a first component, the first component adapted to be coupled to a second component, an outer collar positioned around the first component, the outer collar adapted to be threadingly coupled to the second component, means for coupling the outer collar to the first component, means for retaining the outer collar in a retracted position, and a plurality of collet fingers positioned between the outer collar and the first component, the outer collar having a surface that is adapted to engage the collet fingers and urge the collet fingers into engagement with the first and second components when the outer collar is threadingly coupled to the second component.

The present invention is also directed to various methods of coupling a first component to a second component. In one illustrative embodiment, the method comprises rotatably coupling a rotatable outer collar to the first component, wherein a plurality of collet fingers are positioned between the rotatable outer collar and the first component, positioning the first component adjacent the second component, and rotatably coupling the outer collar to the second component, wherein a surface of the outer collar urges the collet fingers into engagement with the first and second components.

In another illustrative embodiment, the method comprises rotatably coupling a rotatable outer collar to the first component, wherein a means for clamping the first and second components together is positioned between the rotatable outer collar and the first component, positioning the first component adjacent the second component, and rotatably coupling the outer collar to the second component, wherein a surface of the outer collar urges the clamping means into engagement with the first and second components.

### BRIEF DESCRIPTION OF THE DRAWINGS

The invention may be understood by reference to the following description taken in conjunction with the accompanying drawings, in which like reference numerals identify like elements, and in which:

FIGS. 1A-1C are partial cross-sectional views of a connector in accordance with one embodiment of the present invention;

FIGS. 2A-2B are partial cross-sectional views of a connector in accordance with another illustrative embodiment of the present invention;

FIGS. 3A-3B are partial cross-sectional views of a connector in accordance with yet another illustrative embodiment of the present invention; and

FIGS. 4A-4B are partial cross-sectional views of another embodiment of the present invention wherein the collet fingers of the connector have a double lug configuration.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In general, the connector of the present invention may be employed to connect two components to one another. As will be recognized by those skilled in the art after a complete reading of the present application, the present invention has broad applicability with respect to the connection of various components to one another. For example, the connector of the present invention may be employed to connect various components, such as a blowout preventer, a production tree, a riser, a tubing head, a running tool, etc. to a subsea or surface wellhead. The present invention may also be employed, if desired, to connect riser sections to one another. For ease of explanation, the present invention will be disclosed in the context of connecting a generic component to a wellhead. However, the present invention should not be considered as limited to connecting any specific components to one another, unless such components are expressly recited in the appended claims.

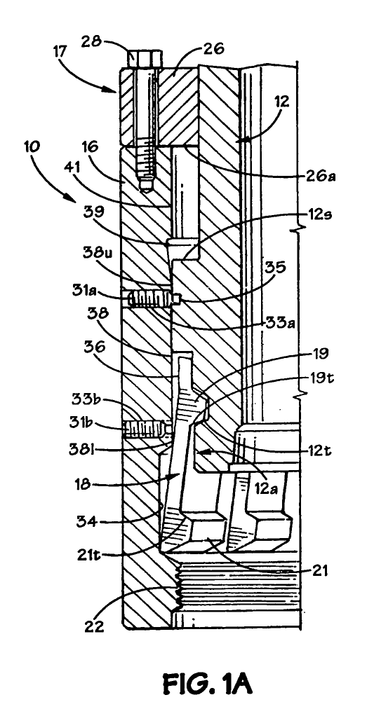

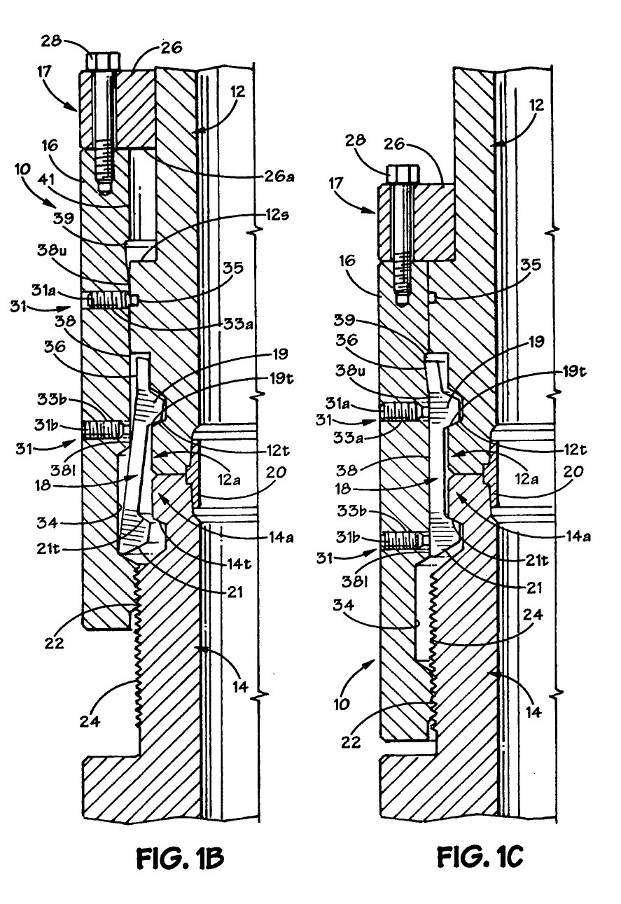

One illustrative embodiment of the present invention will now be described with reference to FIGS. 1A-1C. FIG. 1A is a partial cross-sectional view of the connector 10 coupled to an illustrative first component 12. FIGS. 1B-1C depict an illustrative installation sequence as the connector 10 is used to couple the first component 12 to an illustrative second component 14. In general, the connector 10 is comprised of a rotatable outer collar 16, a plurality of collet fingers 18, and means 17 for coupling the outer collar 16 to the first component 12. In the embodiment depicted in FIGS. 1A-1C, the means 17 comprises a split ring 26 that is threadingly coupled to the outer collar 16 by a plurality of threaded fasteners 28. The first and second components 12, 14 are adapted to be coupled to one another through use of the connector 10 described herein. A seal 20 (see FIG. 1B) may be provided at the interface between the first and second components 12, 14. As indicated above, the present invention has a broad application and may be employed with any of a variety of components that are adapted to be coupled to one another. By way of illustration only, the present invention will be discussed in the context where the first component 12 is coupled to a portion of an illustrative Christmas tree and the second component 14 is a portion of a wellhead.

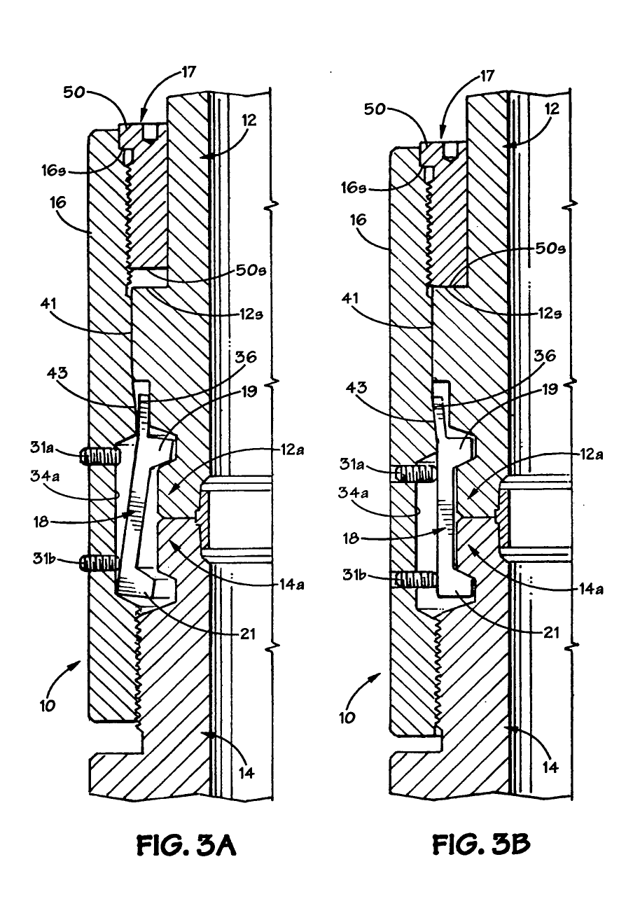

In one illustrative embodiment, the means 17 for connecting the collar 16 to the first component 12 comprises the split ring 26. A surface 26a of the split ring 26 is adapted to engage a shoulder 12s on the first component 12. FIGS. 3A-3B depict an alternate means 17 for coupling the collar 16 to the first component 12. As shown therein, the means 17 may comprise an externally threaded split ring 50 that is adapted to engage an internally threaded portion of the collar 16. A surface 50s of the threaded split ring 50 is adapted to engage the shoulder 12s on the first component 12. The split ring 50 is also adapted to engage the shoulder 16s on the collar 16 when the split ring 50 is completely installed. The physical size of the split rings 26 and 50 may vary depending upon the particular application. The physical size of the collar 16 may also vary depending upon the particular application. For example, the collar 16 may have a wall thickness of approximately ⅞″-1½″ depending upon the particular application.

In the illustrative embodiments depicted herein, the connector 10 comprises a plurality of engaging members 31 that may be employed, in at least some embodiments, to engage the collet fingers 18, as described more fully below. The engaging members 31 may also serve other purposes. In the illustrative embodiment depicted in FIGS. 1A-1C, the engaging members 31 comprise a plurality of upper engaging members 31a and a plurality of lower engaging members 31b. The engaging members 31 may be of any desired structure sufficient to accomplish the purposes described herein for the members 31. In the illustrative embodiment depicted in FIGS. 1A-1C, the engaging members 31 are comprised of threaded set screws that are positioned in threaded openings 33a, 33b formed in the collar 16. In one particular embodiment, there are an equal number of upper and lower engaging members 31a, 33b spaced around the perimeter of the collar 16. In one embodiment, an upper engaging member 31a and a lower engaging member 33b are adapted to engage a single collet finger 18, i.e., there is an upper engaging member 31a and a lower engaging member 33b for each of the plurality of collet fingers 18. At least some of the upper engaging members 31a are adapted to be positioned in a recess 35 formed on the outer surface of the first component 12. In one illustrative embodiment, the recess 35 may be a groove formed around the perimeter of the first component 12.

In the embodiment depicted in FIGS. 1A-1C, the collar 16 has a generally cylindrical surface 38, at least a portion of which is adapted to engage the collet fingers 18, as described more fully below. In this embodiment, the surface 38 may have substantially the same inside diameter as the surface 41 of the collar 16. A recess 39 is formed in the collar 16 to allow the collet fingers 18 to rotate as the connection is made up, as described more fully below.

The first component 12 has an upper hub profile 12a whereas the second component 14 has a lower hub profile 14a. A tapered surface 12t is formed on the upper hub profile 12a and a tapered surface 14t is formed on the lower hub profile 14a. In the illustrative embodiment depicted in FIGS. 1A-1C, each of the collet fingers 18 comprises an upper lug 19 and a lower lug 21. A tapered surface 19t is formed on the upper lug 19 and a tapered surface 21t is formed on the lower lug 21. As described more fully below, the tapered surface 19t is adapted to engage the tapered surface 12t on the upper hub profile 12a, whereas the tapered surface 21t is adapted to engage the tapered surface 14t on the lower hub profile 14a. By causing these various tapered surfaces to engage one another, the first and second components 12, 14 may be coupled to one another.

The size and configuration of the collet fingers 18 may vary depending upon the particular application. The collet fingers 18 constitute means for clamping the profiles 12a, 14a and the first and second components 12, 14, respectively, to one another. The collet fingers 18 may be engaged by a portion of the collar 16 and/or by one or more of the engaging members 31, depending upon the particular application. The number of collet fingers 18 employed may vary depending upon the particular application. In one illustrative embodiment where the first and second components 12, 14 have a diameter of approximately 16-20 inches, 18-24 collet fingers 18 may be equally spaced around the perimeter of the first and second components 12, 14. As will be recognized by those skilled in the art after a complete reading of the present application, the physical size of the various components and structures depicted in the drawings may vary depending on the particular application. For example, the size, shape and configuration of the collet fingers 18 and the lugs 19, 21 may be varied, and the configuration of the portion of the collar 16 that may engage the collet fingers 18, e.g., the surface 38, may be varied while still accomplishing the benefits of the present invention.

One illustrative technique of using the connector described herein will now be explained with reference to FIGS. 1A-1C. FIG. 1A depicts the situation prior to the first component 12 being coupled to the second component 14. As shown therein, the outer collar 16 is held in a retracted position by one or more of the upper set screws 31a which engage the recess 35, e.g., an OD groove formed on the first component 12. In the retracted position, the lower end 381 of the surface 38 may engage the collet fingers 18. The lower engaging members 31b may be threaded inward to secure the collet fingers 18 in the outwardly-rotated position depicted in FIG. 1A. In this outwardly-rotated position, the lower lug 21 of each collet finger 18 will clear the lower hub profile 14a when the first and second components 12, 14 are coupled to one another. There is a sufficient recess or clearance 34 within the inside diameter of the collar 16 to allow the collet fingers 18 to fully retract or rotate. In the position depicted in FIG. 1A, the first connector 12 is now adapted to be coupled to the second connector 14.

FIG. 1B depicts the situation when the upper and lower hub profiles 12a, 14a are brought together. The seal 20 may be provided between the hub profiles 12a, 14a. Thereafter, the upper and lower set screws 31a, 31b are threaded outward, i.e., the upper set screws 31a are disengaged with the recess 35 and the lower set screws 33b are disengaged from the collet fingers 18. The outer collar 16 is then lowered toward the second component 14. The internal threads 22 formed on the outer collar 16 are adapted to be threaded onto the external threads 24 formed on the second component 14 below the lower hub profile 14a. The threaded connection is established by rotating the outer collar 16 relative to the second component 14. The collar 16 may be rotated using a variety of different tools and techniques. In one illustrative embodiment, a C-spanner type tool (not shown) may be employed.

As the outer collar 16 is threadingly coupled to the second component 14, the internal surface 38 contacts the collet fingers 18 and forces them into engagement with the upper and lower hub profiles 12a, 14a. This process continues until the collet fingers 18 are fully engaged with the upper and lower hub profiles 12a, 14a, i.e., until the tapered surface 19t on each of the collet fingers 18 engages the tapered surface 12t on the upper hub profile 12a and the tapered surface 21t on each of the collet fingers 18 engages the tapered surface 14t on the lower hub profile 14a, thereby coupling the first and second components 12, 14 to one another.

Once the outer collar 16 is completely threaded onto the second component 14, as indicated in FIG. 1C, the upper and lower set screws 31a, 31b may be threaded inward such that they engage and further energize the collet fingers 18 against the hub profiles 12a, 14a. In some applications, the collet fingers 18 may not be fully engaged with the upper and lower hub profiles 12a, 14a until the engaging members 31a, 33b are engaged with the collet fingers 18. In some cases, both the engaging members 31a, 33b and the surface 38 of the collar 16 are used to energize the collet fingers 18. Note that, in the position depicted in FIG. 1C, a lip 36 formed on the collet fingers 18 is positioned within a recess 39 formed in the interior surface of the collar 16.

In the installed position, the surface 26a of the split ring 26 engages the shoulder 12s on the first component 12. Accordingly, the outer collar 16 is rigidly connected to both the upper component 12 via the split ring 26 and the lower component 14 via the threaded connection between the outer collar 16 and the second component 14. The outer collar 16 and/or the engaging members 31a, 31b add strength and bending resistance to the connector 10 in addition to that which is provided by the collet fingers 18 alone. Loads which may be induced on the connector 10 include separation forces caused by axial tension and/or internal pressure, as well as bending and tortional loads caused by operations above the second component 14. The collet fingers 18 provide a tight fit between the hub profiles 12a, 14a and are strengthened additionally by the outer collar 16 through the lower threaded connection between the collar 16 and the second component 14 and the split ring 26. The threaded connection between the outer collar 16 and the second component 14 also provide for substantially quicker makeup of the connection over standard flanged connectors.

Referring again to FIGS. 1B and 1C, when it is desired to retrieve the connector, the installation procedure is essentially reversed. The upper and lower set screws 31a, 33b are threaded outward and the outer collar 16 is unscrewed from the second component 14. As the outer collar 16 is raised, the upper end 38u of the surface 38 engages the lip 36 on the collet fingers 18, thus causing the collet fingers 18 to rotate in a clockwise fashion. Then, the collar 16 is moved upward to its fully retracted position as depicted in FIG. 1A. Once the outer collar 16 is in the fully retracted position, it may be retained in that position by threading one or more of the upper set screws 31a into the recess 35 formed on the first component 12. The lower set screws 31b may also be threaded inward to insure full retraction or rotation of the collet fingers 18. The first component 12 can then be disengaged from the second component 14.

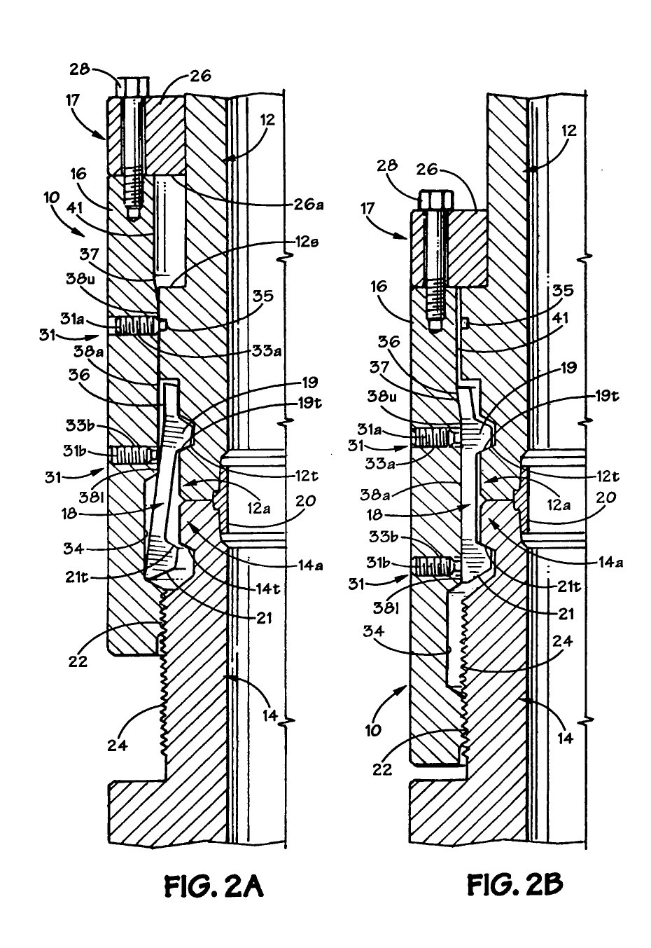

FIGS. 2A-2B depict an alternative embodiment of a connector in accordance with the present invention. In general, in this embodiment, the internal surface of the collar 16 has a slightly different configuration relative to that depicted in FIGS. 1A-1C. As shown in FIGS. 2A-2B, the collar 16 has a surface 38a that is adapted to engage the collet fingers 18. However, in this embodiment, the surface 38a has an inside diameter that is less than the inside diameter of the inner surface 41 of the collar 16. A tapered transition surface 37 is provided between the inner surface 41 of the collar 16 and the inner surface 38a of the collar 16. The operation of the connector 10 depicted in FIGS. 2A-2B is very similar to that described previously with respect to FIGS. 1A-1C. However, in this embodiment, the tapered surface 37 is adapted to engage the lip 36 on the collet fingers 18, as indicated in FIG. 2B. As with the previous embodiments, once the collar 16 is in the installed position, the surface 38a and/or the upper and lower engaging members 31a, 31b may engage the collet fingers 18 and thereby provide the necessary support for the mated connection. The stepped profile of the interior surfaces 41, 38a of the collar 16, as depicted in FIGS. 2A-2B, may be applied in various situations depending upon the particular application.

FIGS. 3A-3B depict yet another illustrative embodiment of a connector 10 in accordance with the present invention. In this embodiment, the collar 16 is provided with an inwardly tapered surface 43 that is adapted to engage the lip 36 formed on the collet fingers 18. The collar 16 is further provided with an enlarged recess area 34a as compared to the recess 34 shown, for example, in FIGS. 1A-1C. The surface 43 tapers inward from the nominal inside diameter of the inner surface 41 of the collar 16. The operation of the connector 10 depicted in FIGS. 3A-3B is substantially similar to that described previously with respect to FIGS. 1A-1C. Also note that, in the embodiment depicted in FIGS. 3A-3B, an externally threaded split ring 50 is employed to couple the collar 16 to the first component 12. A portion of the collar 16 is provided with internal threads to match the external threads on the split ring 50. A shoulder 50s on the split ring 50 is adapted to engage the shoulder 12s on the first component 12 when the connector 10 is in the installed position, as depicted in FIG. 3B.

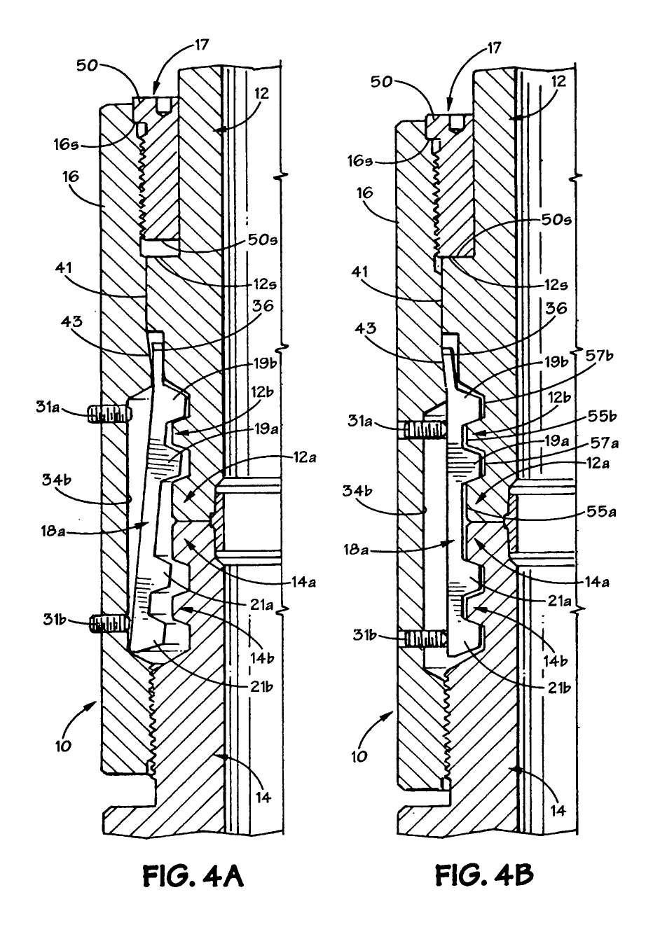

FIGS. 4A-4B depict yet another illustrative embodiment of a connector 10 in accordance with the present invention. In the connector 10 shown in these drawings, the collet fingers 18a are provided with multiple lugs 19, 21 that are adapted to engage the first and second components 12, 14, respectively. More specifically, the collet fingers 18a depicted in FIGS. 4A-4B are comprised of a plurality of upper lugs 19a, 19b that are adapted to engage a plurality of profiles 12a, 12b formed on the first component 12, and a plurality of lower lugs 21a, 21b that are adapted to engage profiles 14a, 14b formed on the second component 14. Any engagement between the various profiles and the lugs on the collet 18 may occur along tapered surfaces in a similar manner to that described above with respect to the embodiment shown in FIGS. 1A-1C. The number, size and configuration of the multiple lugs depicted in FIGS. 4A-4B for the collet fingers 18a may vary depending upon the particular application. Also note that the collar 16 is provided with a relatively long recess 34b to accommodate the extra length collet fingers 18a. The embodiment of the collet fingers 18a depicted in FIGS. 4A-4B may be employed with the other configurations of the collar 16 depicted in FIGS. 1A-3B discussed previously.

The configuration of the hub profiles 12a, 14a may vary depending upon the particular application. For example, with reference to FIG. 4B, the surfaces 55a, 55b may have approximately the same outer diameter or they may have differing outer diameters. Similarly, the groove surfaces 57a, 57b may have approximately the same outer diameter or they may have differing outer diameters. The outer diameter of these various surfaces 55a, 55b, 57a, 57b may be arranged in any desired configuration. In the illustrative example depicted in FIG. 4B, the surfaces 55a, 55b have approximately the same outer diameters, and the groove surfaces 57a, 57b have approximately the same outer diameter which is less than the outer diameter of the surfaces 55a, 55b. In another embodiment (not depicted in the drawings), the surface 55b has a greater outer diameter than the surface 55a and the outer diameter of the surfaces 57a, 57b are different from one another. In view of the foregoing, it should be understood that the configuration of the hub profiles 12a, 14a should not be considered a limitation of the present invention.

The present invention is directed to various embodiments of a connector. In one illustrative embodiment, the connector comprises a first component, the first component adapted to be coupled to a second component, an outer collar positioned around the first component, the outer collar adapted to be threadingly coupled to the second component, and a plurality of collet fingers positioned between the outer collar and the first component, the outer collar having a surface that is adapted to engage the collet fingers and urge the collet fingers into engagement with the first and second components when the outer collar is threadingly coupled to the second component.

In another illustrative embodiment, the connector comprises a first component, the first component adapted to be coupled to a second component, an outer collar positioned around the first component, the outer collar adapted to be threadingly coupled to the second component, and a plurality of collet fingers positioned between the outer collar and the first component, the outer collar having a substantially cylindrical surface that is adapted to engage the collet fingers and urge the collet fingers into engagement with the first and second components when the outer collar is threadingly coupled to the second component, wherein each of the collet fingers has a first tapered surface that is adapted to engage a tapered surface formed on the first component and each of the collet fingers has a second tapered surface that is adapted to engage a tapered surface formed on the second component.

In yet another illustrative embodiment, the connector comprises a first component, the first component adapted to be coupled to a second component, an outer collar positioned around the first component, the outer collar adapted to be threadingly coupled to the second component, means for coupling the outer collar to the first component, means for retaining the outer collar in a retracted position, and a plurality of collet fingers positioned between the outer collar and the first component, the outer collar having a surface that is adapted to engage the collet fingers and urge the collet fingers into engagement with the first and second components when the outer collar is threadingly coupled to the second component.

The present invention is also directed to various methods of coupling a first component to a second component. In one illustrative embodiment, the method comprises rotatably coupling a rotatable outer collar to the first component, wherein a plurality of collet fingers are positioned between the rotatable outer collar and the first component, positioning the first component adjacent the second component, and rotatably coupling the outer collar to the second component, wherein a surface of the outer collar urges the collet fingers into engagement with the first and second components.

In another illustrative embodiment, the method comprises rotatably coupling a rotatable outer collar to the first component, wherein a means for clamping the first and second component together is positioned between the rotatable outer collar and the first component, positioning the first component adjacent the second component, and rotatably coupling the outer collar to the second component, wherein a surface of the outer collar urges the means for clamping into engagement with the first and second components.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. An apparatus, comprising:
a first component, said first component adapted to be coupled to a second component;
an outer collar positioned around said first component, said outer collar adapted to be threadingly coupled to said second component; and
a plurality of collet fingers positioned between said outer collar and said first component, said outer collar having a surface that is adapted to engage said collet fingers and urge said collet fingers into engagement with said first and second components when said outer collar is threadingly coupled to said second component.

2. The apparatus of claim 1, wherein said first component is comprised of at least one of a Christmas tree, a riser and a wellhead.

3. The apparatus of claim 1, wherein said second component is comprised of at least one of a Christmas tree, a riser and a wellhead.

4. The apparatus of claim 1, further comprising means for coupling said outer collar to said first component.

5. The apparatus of claim 4, wherein said means for coupling said outer collar to said first component comprises a split ring that is positioned around said first component and threadingly coupled to said outer collar by a plurality of threaded fasteners.

6. The apparatus of claim 4, wherein said means for coupling said outer collar to said first component comprises an externally threaded split ring that is adapted to threadingly engage internal threads formed on said collar.

7. The apparatus of claim 1, further comprising a means for retaining said outer collar in a retracted position.

8. The apparatus of claim 7, wherein said means for retaining said outer collar in a retracted position comprises a plurality of threaded devices that are positioned in openings formed in said outer collar, said threaded devices adapted to engage a portion of said first component.

9. The apparatus of claim 1, further comprising a plurality of threaded devices positioned in openings formed in said outer collar, said threaded devices being adapted to engage at least one of said plurality of collet fingers.

10. The apparatus of claim 1, wherein said surface of said collar that engages said plurality of collet fingers comprises a substantially cylindrical surface.

11. The apparatus of claim 1, wherein said surface of said collar that engages said plurality of collet fingers comprises a tapered surface.

12. The apparatus of claim 1, wherein said collet fingers comprise a lip and said surface of said collar that engages said plurality of collet fingers comprises a tapered surface.

13. The apparatus of claim 1, wherein each of said collet fingers has a first tapered surface that is adapted to engage a tapered surface formed on said first component.

14. The apparatus of claim 13, wherein each of said collet fingers has a second tapered surface that is adapted to engage a tapered surface formed on said second component.

15. The apparatus of claim 1, wherein each of said collet fingers comprises first and second lugs, wherein said first lug is adapted to engage said first component and said second lug is adapted to engage said second component when said collet fingers are in an installed position.

16. The apparatus of claim 1, wherein each of said collet fingers is comprised of a first plurality of lugs and a second plurality of lugs, wherein said first plurality of lugs are adapted to engage said first component and said second plurality of lugs are adapted to engage said second component when said collet fingers are in an installed position.

17. The apparatus of claim 5, wherein said split ring has a surface that is adapted to engage a shoulder formed on said first component when said outer collar is moved to an installed position.

18. The apparatus of claim 1, wherein said outer collar is threadingly coupled to said second component by engagement of an internal threaded surface on said outer collar with an externally threaded surface on said second component.

19. An apparatus, comprising:
a first component, said first component adapted to be coupled to a second component;
an outer collar positioned around said first component, said outer collar adapted to be threadingly coupled to said second component; and
a plurality of collet fingers positioned between said outer collar and said first component, said outer collar having a substantially cylindrical surface that is adapted to engage said collet fingers and urge said collet fingers into engagement with said first and second components when said outer collar is threadingly coupled to said second component, wherein each of said collet fingers has a first tapered surface that is adapted to engage a tapered surface formed on said first component and each of said collet fingers has a second tapered surface that is adapted to engage a tapered surface formed on said second component.

20. The apparatus of claim 19, wherein said first component is comprised of at least one of a Christmas tree, a riser and a wellhead.

21. The apparatus of claim 19, wherein said second component is comprised of at least one of a Christmas tree, a riser and a wellhead.

22. The apparatus of claim 19, further comprising means for coupling said outer collar to said first component.

23. The apparatus of claim 22, wherein said means for coupling said outer collar to said first component comprises a split ring that is positioned around said first component and threadingly coupled to said outer collar by a plurality of threaded fasteners.

24. The apparatus of claim 22, wherein said means for coupling said outer collar to said first component comprises an externally threaded split ring that is adapted to threadingly engage internal threads formed on said collar.

25. The apparatus of claim 19, further comprising a means for retaining said outer collar in a retracted position.

26. The apparatus of claim 25, wherein said means for retaining said outer collar in a retracted position comprises a plurality of threaded devices that are positioned in openings formed in said outer collar, said threaded devices adapted to engage a portion of said first component.

27. The apparatus of claim 19, further comprising a plurality of threaded devices positioned in openings formed in said outer collar, said threaded devices being adapted to engage at least one of said plurality of collet fingers.

28. The apparatus of claim 19, wherein said collar further comprises a tapered surface that is adapted to engage said plurality of collet fingers.

29. The apparatus of claim 28, wherein said collet fingers comprise a lip and said tapered surface of said collar engages said lip of said plurality of collet fingers.

30. The apparatus of claim 23, wherein said split ring has a surface that is adapted to engage a shoulder formed on said first component when said outer collar is moved to an installed position.

31. The apparatus of claim 19, wherein said outer collar is threadingly coupled to said second component by engagement of an internal threaded surface on said outer collar with an externally threaded surface on said second component.

32. An apparatus, comprising:
a first component, said first component adapted to be coupled to a second component;
an outer collar positioned around said first component, said outer collar adapted to be threadingly coupled to said second component; and
means for clamping said first component to said second component, said means for clamping being positioned between said outer collar and said first component, said outer collar having a surface that is adapted to urge said means for clamping into engagement with said first and second components when said outer collar is threadingly coupled to said second component.

33. The apparatus of claim 32, wherein said means for clamping comprises a plurality of collet fingers.

34. The apparatus of claim 32, further comprising means for coupling said outer collar to said first component.

35. The apparatus of claim 32, further comprising a means for retaining said outer collar in a retracted position.

36. An apparatus, comprising:
a first component, said first component adapted to be coupled to a second component;
an outer collar positioned around said first component, said outer collar adapted to be threadingly coupled to said second component;
means for coupling said outer collar to said first component;
means for retaining said outer collar in a retracted position; and
a plurality of collet fingers positioned between said outer collar and said first component, said outer collar having a surface that is adapted to engage said collet fingers and urge said collet fingers into engagement with said first and second components when said outer collar is threadingly coupled to said second component.

37. The apparatus of claim 36, wherein said means for coupling said outer collar to said first component comprises a split ring that is positioned around said first component and threadingly coupled to said outer collar by a plurality of threaded fasteners.

38. The apparatus of claim 36, wherein said means for coupling said outer collar to said first component comprises an externally threaded split ring that is adapted to threadingly engage internal threads formed on said collar.

39. The apparatus of claim 36, wherein said means for retaining said outer collar in a retracted position comprises a plurality of threaded devices that are positioned in openings formed in said outer collar, said threaded devices adapted to engage a portion of said first component.

40. The apparatus of claim 36, further comprising a plurality of threaded devices positioned in openings formed in said outer collar, said threaded devices being adapted to engage at least one of said plurality of collet fingers.

41. The apparatus of claim 36, wherein said outer collar is threadingly coupled to said second component by engagement of an internal threaded surface on said outer collar with an externally threaded surface on said second component.

42. A method of coupling a first component to a second component, comprising:
rotatably coupling a rotatable outer collar to said first component, wherein a plurality of collet fingers are positioned between said rotatable outer collar and said first component;
positioning said first component adjacent said second component; and
rotatably coupling said outer collar to said second component, wherein a surface of said outer collar urges said collet fingers into engagement with said first and second components.

43. The method of claim 42, further comprising urging a plurality of threaded devices positioned in said outer collar into engagement with said collet fingers.

44. The method of claim 42, wherein rotatably coupling said rotatable outer collar to said first component comprises threadingly coupling a split ring to said outer collar using a plurality of threaded fasteners.

45. The method of claim 42, wherein rotatably coupling said rotatable outer collar to said first component comprises threadingly coupling an externally threaded split ring to an internally threaded portion of said rotatable outer collar.

46. The method of claim 42, wherein rotatably coupling said outer collar to said second component comprises threadingly coupling an internally threaded portion of said collar with an externally threaded portion of said second component.

47. A method of coupling a first component to a second component, comprising:
rotatably coupling a rotatable outer collar to said first component, wherein a means for clamping said first and second components together is positioned between said rotatable outer collar and said first component;
positioning said first component adjacent said second component; and
rotatably coupling said outer collar to said second component, wherein a surface of said outer collar urges said means for clamping into engagement with said first and second components.

48. The method of claim 47, wherein said means for clamping comprises a plurality of collet fingers.

49. The method of claim 47, further comprising urging a plurality of threaded devices positioned in said outer collar into engagement with said means for clamping.

50. The method of claim 47, wherein rotatably coupling said rotatable outer collar to said first component comprises threadingly coupling a split ring to said outer collar using a plurality of threaded fasteners.

51. The method of claim 47, wherein rotatably coupling said rotatable outer collar to said first component comprises threadingly coupling an externally threaded split ring to an internally threaded portion of said rotatable outer collar.

52. The method of claim 47, wherein rotatably coupling said outer collar to said second component comprises threadingly coupling an internally threaded portion of said collar with an externally threaded portion of said second component.
